(19) United States
(12) Patent Application Publication
(10) Pub. No.: US 2011/0211733 A1
(43) Pub. Date: Sep. 1, 2011

(54) CROP THINNING SYSTEMS

(76) Inventor: Michael W. SCHWARZ, Cambridge (NZ)

(21) Appl. No.: 12/869,121

(22) Filed: Aug. 26, 2010

(30) Foreign Application Priority Data
Aug. 27, 2009 (NZ) 579309

(51) Int. Cl. G06K 9/00; A01B 41/00

(52) U.S. Cl. 382/110; 47/1.43

(57) ABSTRACT

A thinning or weeding apparatus includes an image processing apparatus. The image processing apparatus includes an automated visual detection system which includes a visual sensor system and an image processing system capable of receiving an image from the visual sensor system. The image processing apparatus then processes the image in the image processing system to determine where plants are located and to determine which plants will be thinned or weeded and which will not.

This invention relates to an improved crop thinning and weeding system. In particular, this invention relates to a mechanical crop thinning and weeding system to be used in the thinning and weeding of crop plants such as lettuce.

Reference throughout this specification shall now be made to use of the present invention in relation to the thinning and weeding of lettuce plants.

However, this should not be seen to be a limitation on the present invention in any way as the present invention may be used to thin other crops that are over-planted initially and subsequently require thinning or weeding to encourage optimum growth and harvesting or to weed other crops.

### BACKGROUND ART

It is common practice that when planting crops, the crop may be overplanted such that the initial density of the crop plants may be more than the density ultimately desired to be grown in the planted area, or more than the area could reasonably support with maturing plants.

This is because, there will be losses in the number of plants initially planted, due to the affects of a variety of environmental factors, or poor germination, or due to the activities of animals, microorganisms, fungi, the robustness of the individual plant and so forth. For example, newly planted or emerging seedlings may be eaten by birds, rabbits, slugs/snails, insects, and so forth; and/or climatic conditions may cause a proportion of the seedling plants to die—such as from too much water, not enough water, storms, or by effecting microclimatic conditions which foster diseases which kill the plants.

Further, it is not beneficial to overcrowd maturing plants, which in turn could result in conditions arising which make the plants more susceptible to disease, or prevent the maturing plant achieving its growth potential. Therefore, the practice of thinning the crop plants is typically employed at one or more preferred times throughout the growth period of the crop plant.

Thinning of any crop is a major task. Where crop thinning is undertaken manually, it is a common practice for crop farmers to employ additional staff on a casual basis for a limited period simply to achieve the task of thinning a crop. The outcome of the thinning process is to ensure the remaining plants, once the crop is thinned, have enough space to grow to optimum potential. This can be an expensive and time consuming operation. In addition, there is often a limited window of opportunity during which the thinning is undertaken, so that the process does not negatively impact on the plants remaining, whilst in turn ensuring there is the required time period left for the remaining plants to reach maturity or achieve the growth required by the time the crop is due for harvesting. Much of the process is driven by the available set optimum growth period and conditions relevant to the specific crop. In addition, there is a subjective element to the manual thinning process whereby strong plants are preferably retained, whilst weak plants would be thinned out.

The task of thinning crops is further influenced by the frequently substantial areas the planted crop occupies, the size of the individual crop plants, or features specific to the individual crop which impacts on the time taken to achieve the thinning process and the ease with which the thinning process can be completed.

Most crops have issues specific to the crop which require consideration. For example, in relation to the thinning of lettuce, the lettuce plants are substantially soft-tissued plants, easily damaged by physical or mechanical processes; the growing season is relatively short; and most individual plants—whether as seedlings, or mature plants ready for harvesting—are leafy, more open, and not dense. Some varieties, such as Iceberg, however do develop quite a dense head in a mature plant.

In relation to the limitations of growing seasons, this is exampled by lettuce crops in the Salinas Valley, Calif., United States of America, where the growing season extends from March until October; whilst in Southern Arizona, the growing season extends from October until March. Most of the lettuce for the USA is grown in these regions.

Most of this lettuce is planted by seed at around 50 mm spacing. When the plants are between 20 mm to 50 mm in height, they must be thinned to a spacing of 180 mm to 250 mm depending on the variety. This is traditionally done by hand and costs around US $130 per acre; which amounts to costs in excess of US $25 million per year.

One big disadvantage is that if the crop farmer cannot get enough people to work at thinning the crop at the correct time, the crop can be spoiled or downgraded and therefore the grower can get significantly reduced revenue for the crop. It can also be difficult to get enough individuals having the requisite knowledge and skills in order to do it correctly.

Currently a team of individual thinners will move through a field removing the lettuce seedlings they determine require removing. The manual thinning of lettuce is physically difficult as the thinners may need to generally stoop if removing the lettuce seedling by hand, or engage in repetitive movements if using tools. This not only slows the whole process but can also cause repetitive strain injuries to occur.

Even having regard to any systems designed to address some if not all of the above difficulties, the issues are that the system needs to be able to thin the crop in a manner which leaves the robust plants, leaves sufficient space for the remaining plants to grow optimally and achieves the process without any such thinning apparatus damaging the remaining plants.

Often mechanical crop thinning systems are designed to move across a growing patch and pick out the crop plants randomly as the crop thinning apparatus is moving. There may be little if any emphasis on the quality of the plants removed or left behind. As can also be appreciated, there is a need to ensure the apparatus does not bruise or damage the remaining crop by sheer physical blunt force. In addition, the pressure of the structure of the apparatus may damage sensitive roots. Further, in situations where the ground is not flat, mounds may result in the thinning process not being adequately achieved because the apparatus may be unable to accommodate differences in ground undulations.

It would therefore be advantageous to have a crop thinning system which included crop thinning apparatus which:
a) Could follow (be towed), or be mounted on, a tractor or be self-powered and thereby minimize the need for on total reliance on manual labour to effect the thinning process; and/or
b) Could include monitoring systems which worked alone or in conjunction with other means (such as a towing vehicle) in determining movement of the crop thinning apparatus relative to the ground over which it traveled to that required to achieve the crop thinning in a manner that did not damage the crop; and/or
c) Could include detecting systems capable of detecting ground undulations and thereby adjust the thinning mechanism(s) to ensure the thinning process was not affected; and/or
d) Could include detecting systems capable of detecting the location of the crop plants and the required distance between remaining neighboring crop plants thereby enabling the crop to be appropriately thinned; and/or
e) Could include crop grasping apparatus to ensure only individual or identified crop plants are removed during the thinning process, without impacting on those left behind; and/or
f) Could include or be adapted to include a grading system, so that as the crop is thinned with the remaining plants identified and left because they have been graded according to specific parameters.

It would therefore be advantageous to have an invention that offered at least some if not all of the advantages of the above proposed system. Further more many of the disadvantages associated with thinning also apply when weeding and it would therefore be advantageous to provide a weeding system including weeding apparatus which would facilitate or improve weeding of crops.

It is therefore an object of the present invention to consider the problems previously alluded to and provide at least one solution which addresses one or more of these problems.

It is a further object of the present invention to at least provide the public with a useful choice, or alternative system.

Further aspects and advantages of the present invention will become apparent from the ensuing description which is given by way of example only. It should be appreciated that variations to the described embodiments are possible and would fall within the scope of the present invention.

### BRIEF DISCLOSURE OF INVENTION

For the purpose of describing the current invention, reference shall be made to a crop thinning apparatus. In particular, the invention shall be described with reference to a crop thinning apparatus for lettuce. However, it is to be understood that such description shall not limit the scope or application of the invention only to thinning lettuce crops. It should be appreciated that the current invention may be adapted for use in thinning or weeding a variety of crops, yet still be encompassed within the scope of the present invention.

For the purpose of the present invention the term crop shall mean and include any plant grown within the ground.

For the purpose of the present invention the term thinning shall mean and include the action of selectively removing individual plants to achieve a preferred quantity of plants in a predetermined area, growing at a preferred predetermined distance from each other. Thus in this specification where the word “thinning” is used alone that word shall also include “weeding” within its scope.

Having regard to the systems currently existing for thinning or weeding crops one potentially realizable advantage of the present invention includes the ability to achieve the thinning or weeding of crops more economically using the present invention, as opposed to the manual system employing varying numbers of individuals to work a crop area removing unwanted plants by hand or using tools.

The present invention includes a thinning or weeding apparatus.

In a preferred embodiment, the apparatus is preferably adapted to be mounted to the back of a tractor or any preferred vehicle having motive means. However, the apparatus could be built as unit which is towed by the vehicle.

However, in other embodiments, the apparatus may be motorized.

The apparatus is preferably designed to pass across/over beds of planted lettuce. Preferably, the apparatus is adapted to thin multiple rows of crop plants at the same time.

According to a preferred embodiment of the present invention the thinning apparatus includes image processing apparatus. The image processing apparatus is an automated visual detection system which comprises a visual sensor system and an image processing system capable of receiving an image from the visual sensor system and processing said image in the image processing system to determine where the crop plants are located and to determine whether the crop plants are at a preferred predetermined spacing. The information is then used to determine which crop plants will be thinned or weeded and which will not.

Thus the image processing apparatus preferably includes a visual sensor system adapted to capture or record an image of the lettuce bed, or individual lettuce plants over which the thinning apparatus travels. Multiple image capturing devices may be included in or on the thinning apparatus.

The image capturing device is preferably adapted to continually take images of the lettuce plants passing underneath the thinning apparatus.

The image capturing device may be any appropriate optical or electro-optical sensor, including an optical video, a CCD camera (using a charge-coupled device and being visible or infra-red sensitive), digital camera, thermal imager, photodiode array, photomultiplier array, avalanche photodiode array or the like and/or series of colour sensors or linescan cameras. A typical CCD camera converts optical brightness into electrical amplitude signals using a charge coupled device (CCD) image sensor. A CCD camera includes a CCD imager 1C (integrated circuit) and control circuits.

The thinning apparatus also preferably includes illumination means, provided to facilitate improved image capturing by the image capturing device(s). In a preferred embodiment of the invention, the illumination means are preferably strobe lamps. However, other illumination means may be included.

The image processing apparatus is further adapted to include processing means. In one preferred embodiment, the processing means includes computer hardware and computer software. The computer software preferably includes a computer program capable of analysing the images captured by the image capturing device and based on programmed parameters is able to determine which plants the apparatus is required to destroy/remove and which to save/leave. Different software would be required for use with the relevant image capturing device, such as a camera, or colour sensors or by linescan cameras, for example.

Preferably, the decisions/outcomes of the action of the processing apparatus are sent to a PLC (programmable logic controller) which is adapted to track the progress of the apparatus as it moves over the ground. In addition, the PLC is further adapted to control the thinning or weeding assembly of the thinning or weeding apparatus. The thinning or weeding assembly operates to destroy a pre-identified plant.

The image processing apparatus is however any computational device able to perform mathematical transformations, image processing, algorithms, selections, sorting and/or any other image processing techniques necessary to determine the preferred predetermined criteria and thus which plants will be destroyed/thinned out and which ones will not.

Preferably, the thinning or weeding assembly includes thinning or weeding means.

In one preferred embodiment, the thinning or weeding means includes a flail.

In one preferred embodiment, the thinning or weeding means rotates. Accordingly, where the thinning or weeding means is a flail, the flail is adapted to rotate. For example, the rotating flail of one preferred embodiment is comprised of a chain which is rapidly spinning.

However, any thinning or weeding means to achieve the desired outcome may be used with or adapted for use with the thinning or weeding assembly. For example, the thinning or weeding means may be one or more lengths of suitably durable and flexible thermoplastics material, lengths of metal wire and so forth. Alternatively, the rotary thinning means, or plant eliminators, could be replaced by mechanical hoes or by spray nozzles to destroy plants.

During the thinning or weeding process, the axis of rotation of the spinning flail is preferably directly above the row of lettuce or other crop plants. The height of the axis of the spinning flail is preferably controlled between a raised position whereby the thinning or weeding action is not achieved, and a lowered operational thinning or weeding position.

When the rotating flail is in the lowered position the flail is preferably low enough to destroy any plants it comes into contact with.

When the processing apparatus determines via the PLC that a plant is not to be destroyed, for example, it is considered to be located at a preferred position/spacing, the flail is raised to a height whereby contact with the plant is avoided and that plant is not subjected to damage. When the thinning apparatus has then passed over that plant, the flail is again lowered to destroy adjacent plants the processing apparatus determines are to be destroyed.

The thinning or weeding apparatus is preferably adapted to thin or weed multiple rows of plants at the same time. Accordingly, the apparatus includes multiple flails, each flail arranged laterally to an adjacent flail and located in an arrangement corresponding to the location of the parallel rows of plants. The position of the flails is preferably adjustable to adapt the apparatus for use with crop plants planted in parallel rows separated by predetermined distances.

In one preferred embodiment of the present invention, the apparatus is configured to thin or weed up to six rows of plants at a time. There are therefore up to six flails, one for each row.

Preferably, the thinning or weeding assembly also includes drive means. The drive means drives the thinning or weeding means. In one preferred embodiment, the motorized means is an hydraulic motor which drives the spinning action of the flails. The flails are each driven by such motorized drive means.

The assembly also further includes positioning means to effect operation of the thinning or weeding means (the flails) between the raised and lowered position. In one embodiment the positioning of the fails in a raised or lowered position is achieved via a pneumatic cylinder—one to each flail.

The thinning or weeding assembly also preferably includes means to determine the preferred height above ground to which the flails are moved to in their lowered position. The height determination is preferably controlled by sensing means. In a preferred embodiment, the sensing means includes ultrasonic ground sensors. There is preferably at least one sensing means to each flail.

The sensing means are preferably monitored by the PLC which, in turn, controls hydraulic cylinders, one to each flail. This system keeps each flail at the correct position in relation to ground level.

The apparatus also preferably is adapted to move sideways so that the flails are always in the correct lateral position. This movement is preferably controlled by a hydraulic cylinder which, in turn, is controlled by the PLC.

The PLC acts on information from the computer which obtains lateral information from information obtained by the image capturing means—such as the camera images.

The apparatus is preferably further adapted to monitor progress as it moves over the ground. In one embodiment of the present invention, the monitoring means is a shaft encoder attached to the ground speed mode PTO on the tractor, in other preferred embodiments, the monitoring means could be or include radar tracking or GPS tracking systems.

The apparatus further includes a thinning or weeding assembly carriage. The assembly carriage includes a frame and at least one enclosure. The frame is configured to correspond in dimensions to the number of parallel rows of crop plants the apparatus is to be used for effecting thinning or weeding of the crop plants in those rows.

The enclosure(s) is adapted to accommodate one or more image recording devices, such as a camera. The image processing means—such as the computer and PLC and associated electronics are also preferably accommodated in enclosures adapted to receive them.

In operation, and when considering the attachment of the thinning or weeding means to the frame and the arrangement of the drive means, positioning means, and sensing means, the thinning or weeding means (such as the rotary flails/eliminators), are preferably hinged from the after part of the frame. The rotary flails include a shaft.

The rotary flail is maintained at the correct distance above the ground by a (hydraulic) positioning cylinder.

The up and down movement of the flail, when it is required to destroy or save plants, is controlled by a pneumatic primary positioning cylinder.

The two cylinders are linked by a pivoting arm.

A ground proximity sensor is attached to either or both the shaft of the rotary flail and to each pivoting arm which links the two positioning cylinders (being the hydraulic and pneumatic cylinders).

As such, for a thinning or weeding apparatus which includes multiple thinning or weeding assemblies, each thinning assembly will include a rotary flail, a shaft to each rotary flail, the two positioning cylinders, a pivoting arm connecting the two positioning cylinders and at least one ground proximity sensor.

In the case of thinning the software inspects the camera images and decides to save plants according to the distance from the previous plant saved. The software in conjunction with the image processing means is also able to look forward to see if there are any gaps in the sequence of the plants yet to be considered. If there are, it can affect the decision to save or destroy each plant as it is being considered. It will also take into account the position of plants to be saved in adjoining rows.

This is so that a staggered pattern will be achieved where plants in one row will not be growing next to a plant in the next row.

The present invention has a number of potentially unique features when compared with the prior art, which will enable the thinning apparatus to have a number of potentially realizable advantages over the prior art. Such features are:
a) The use of strobe lights
b) The use of an arrangement of image capturing devices (such as CCD matrix cameras) for acquiring images of the plants.
c) The ability to achieve a staggered pattern of saved plants in adjacent/parallel rows.
d) The use of a flail-type thinning means.
e) The ability to save plants by lifting the flail above the plants to be saved.
f) The method of keeping the height of the flails at the correct level in relation to the ground surface.

According to one aspect of the present invention there is provided thinning apparatus for use in thinning crop plants, said thinning apparatus including a thinning assembly and a thinning assembly carriage, said thinning assembly including thinning means for thinning the crop plants, positioning means operating in conjunction with sensing means to effect positioning of the thinning means relative to the crop plants, and image processing means for determining which crop plants are to be removed in the thinning process, said thinning assembly carriage being adapted to receive the thinning assembly and further adapted to move with respect to the ground subject to completion of the thinning process.

Again, it should be appreciated that throughout the present specification the term “crop plant” should be understood to relate to a live growing plant; and whilst lettuce is used as an example of a crop plant with which the thinning apparatus is used, this does not limit the present invention only to this plant crop.

It should also be appreciated that when crop plants are first sowed as seeds, they are frequently over-sowed, such that the emerging plants will often be growing close together. The present invention is adapted to thin the growing plants such that the distance between the plants is optimal for growth of the plant remaining after thinning.

As previously stated, where the preferred crop is lettuce, most of the crop is planted by seed at around 50 mm spacing. When the plants are between 20 mm to 50 mm in height they must be thinned to a spacing of 180 mm to 250 mm depending on the variety.

It is therefore to be appreciated that the present invention can be adapted to not only thin lettuce plants to achieve a desired spacing between remaining plants, but also can be used to thin a variety of crop plants each having different spacing requirements.

Throughout this present specification the term “thinning assembly” should be understood to mean the portion of the present invention that comprises the various features which enables the thinning means to be positioned and operate to destroy the unwanted the lettuce plants.

It should also be appreciated that the term “thinning assembly carriage” should be understood to mean the portion of the present invention to which the thinning assembly is attached and which is either connected to a host vehicle in order to be towed, or mounted upon, or provides independent locomotion for the present invention and transfers this to the ground.

To effect operation of the various components, the thinning apparatus includes electronic systems.

According to a further aspect of the present invention there is provided a method of thinning or weeding crop plants by using thinning or weeding apparatus, said thinning or weeding apparatus including, a thinning or weeding assembly carriage, and a thinning or weeding assembly, the method characterised by the steps of:
a) moving the thinning or weeding assembly carriage over a predetermined number of rows of plants, and
b) determining, by use of image processing apparatus the plants to be retained and the plants to be removed, and
c) lowering the thinning or weeding assembly over a plant to be removed and relative to the ground by means of positioning means and sensing means, and
d) activating thinning or weeding means, such that the plant determined to be thinned or weeded out is destroyed; and
e) returning the thinning or weeding assembly to a pre-thinning or pre-weeding position until the next plant to be thinned or weeded is determined by the image processing means, and

Preferably said method is characterized by the thinning or weeding apparatus achieving a staggered pattern of saved plants in adjacent/parallel rows.

It can be seen that the present invention has several potentially realizable advantages over current methods of thinning lettuce plants.

Currently most lettuce plants are thinned manually and this is a very labour intensive process. Accordingly, once the initial cost of the thinning apparatus has been recouped it will be very economical to use as compared to the cost of manual labour.

A further potentially major advantage of the present invention is that unless it is out of service it will always be available for thinning the crop and at any time of the day.

Another potentially realizable advantage of the present invention is that due to the unique thinning assembly and thinning assembly carriage construction, the thinning apparatus does not need to stop during its operation as the thinning assembly carriage continues at a steady pace throughout the operation of the invention, whilst the thinning assembly continues to operate to effect the thinning process.

As can be appreciated from the above discussion, variations to and from the above described embodiments, uses, and applications of the present invention exist and may be made without deviating from the scope of the present invention.

### BRIEF DESCRIPTION OF DRAWINGS

Further aspects of the present invention will become apparent from the following description which is given by way of example only and with reference to the accompanying drawings in which:

FIG. 1 is a diagrammatical side view representation of one preferred embodiment of the present invention;

FIG. 2 is a diagrammatical rear view of the embodiment of FIG. 1;

FIG. 3 is a side elevation as for FIG. 1 of an alternative embodiment of the invention utilizing a spray to destroy unwanted plants;

FIG. 4 is a rear view of the construction of FIG. 3;

FIG. 5 is a plan view of an “X-Y” table usable with a weeding embodiment of the invention;

FIG. 6 is a side view of the construction of FIG. 5;

FIG. 7 is a diagrammatic side elevation of an alternative drip catcher usable in the invention,

FIG. 8 is an end view of the construction of FIG. 7,

FIG. 9 is a flow diagram showing the operation of the invention in a thinning mode; and

FIG. 10 is a flow diagram showing the operation of the invention in weeding mode.

### BEST MODES FOR CARRYING OUT THE INVENTION

With reference to the figures there is illustrated thinning or weeding apparatus for use in thinning crop plants or weeding undesirable plants, generally indicated by arrow 1. The thinning apparatus is adapted to thin crop plants from multiple adjacent and parallel rows, in such a manner that the crop plants are staggered such that a plant in one row does not negatively impact on the growth potential of a plant in an adjacent row.

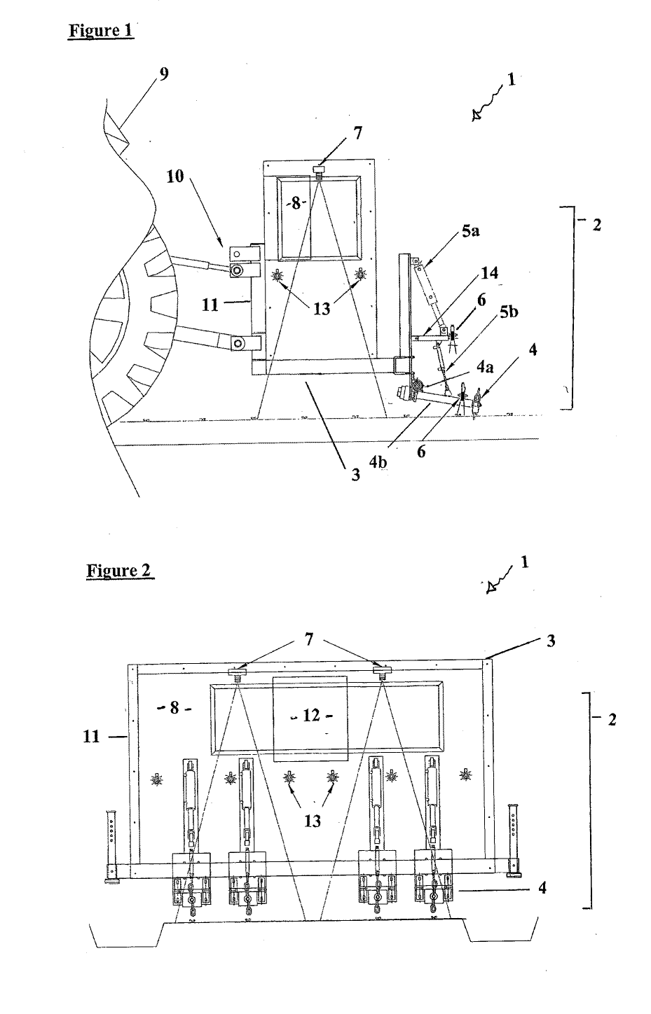

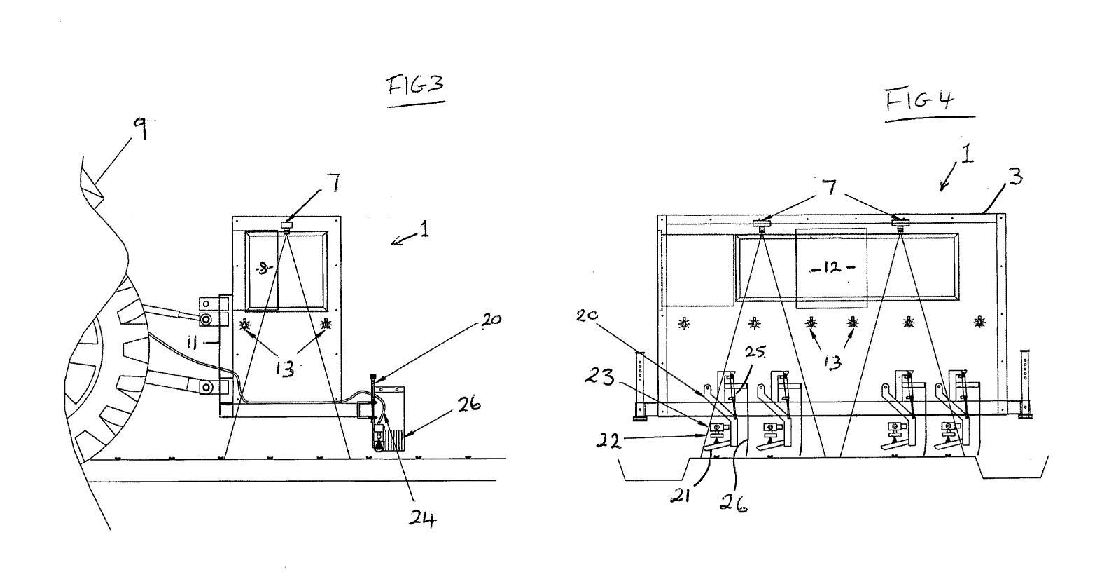

In the case of the thinning apparatus according to FIGS. 1 and 2 the apparatus includes a thinning assembly 2 and a thinning assembly carriage 3.

The thinning assembly includes thinning means 4 for thinning the crop plants. The thinning means is a rotary flail, or other apparatus adapted to destroy the plants determined to be thinned out.

The thinning assembly also includes positioning means 5 operating in conjunction with sensing means 6 to effect positioning of the thinning means relative the crop plants and the ground.

The thinning assembly also includes image processing means for determining which crop plants are to be removed in the thinning process and which crop plants are to be retained within the row. The image processing means includes image capturing devices 7 for capturing images of the crop plants, computer means including computer means retained in computer enclosures 8 consisting of computer hardware, software and PLC which analyses the images taken by the image capturing device(s), and requisite electronic means.

In FIGS. 1 and 2, the thinning assembly carriage is adapted to be connected to a tractor 9 via a three point hitch 10, to facilitate movement of the thinning apparatus across the ground/over the rows of the crop plants to be thinned. However, in other embodiments the thinning apparatus may be adapted to be self propelled.

The thinning assembly carriage consists of a frame 11 with enclosures and this embodiment is for thinning plants in four adjacent, parallel rows. Accordingly, there will be four thinning means 4—being one for each row.

Within the enclosure is one or more image capturing devices, such as cameras 7. Illumination is provided by strobe lamps 13. The computers are in enclosure 8; whilst the electronics and PLC are in enclosure 12.

The rotary flail/eliminators 4 are hinged from the afterpart at 4a of the main frame. Attached to the shaft 4b of each rotary eliminator, and/or to the pivot arm 14, is a ground proximity sensor 6. The correct distance above the ground is maintained by hydraulic position cylinder 5a. The up and down movement of the eliminator when it is required to destroy or save plants is controlled by a pneumatic primary position cylinder 5b. The two position cylinders are linked by a pivot arm 14.

The software inspects the camera images and decides to save plants according to the distance from the previous plant saved. It also looks forward to see if there are any gaps in the sequence of the plants yet to be considered. If there are, it can affect the decision to save or destroy each plant as it is being considered. It will also take into account the position of plants to be saved in adjoining rows. This is so a staggered pattern will be achieved where plants in one row will not be growing next to a plant in the next row.

Accordingly, in use, the thinning apparatus operates to thin crop plants by the thinning assembly carriage moving over a predetermined number of rows of crop plants. The use of image processing apparatus identifies the crop plants to be retained and the crop plants to be removed.

When a crop plant is to be thinned out, the thinning assembly is lowered over the row of crop plants and the crop plant to be removed. The height it is lowered to is determined relative to the ground by means of positioning means and sensing means.

The thinning means operates in a rotating manner such that the crop plant determined to be thinned out is destroyed.

Following destruction of the plant to be thinned, the thinning assembly may be raised to a pre-thinning position until the next crop plant to be thinned is determined by the image processing means. In practice, the thinning assembly is most frequently in the lower position, as more plants are destroyed during the thinning operation, than are saved.

The thinning apparatus achieves a staggered pattern of saved plants in adjacent/parallel rows.

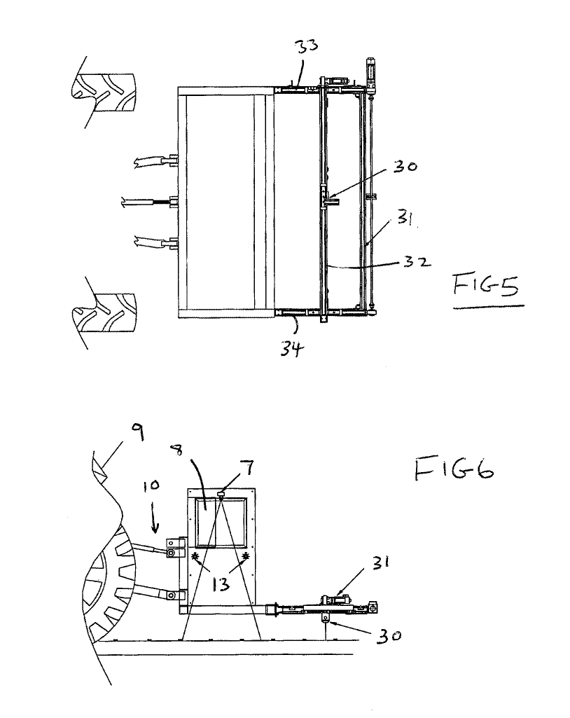

In the construction of FIGS. 3 and 4 an alternative thinning device is shown. Again the device has been constructed to thin four rows of plants at a time. Arms 20 depend from the assembly carriage 3 being pivotally mounted. The arms 20 may be off-set as shown in FIG. 4 principally to achieve the desired geometry but without interfering with nozzles 22 and spray valves 23 as well as to assist in balance.

The arms 20 preferably carry a non-drip construction. To this end an arm 21 is connected to arm 20 and extends outwardly below the nozzle 22. The arm 21 is in the form of a half round so that when in the position shown in FIG. 4 the arm 21 is able to catch drips, if any, from the spray nozzle 22. The spray nozzle 22 is fed from the spray valve 23 which in turn is fed from a spray line 24. The spray line 24 is fed by a suitable pump drawing spray from a bulk container thereof.

The arm 20 is moved about its pivot point by a suitable device such as piston and cylinder assembly 25. When the piston of the piston and cylinder assembly 25 is withdrawn into the cylinder the arm 20 pivots and the arm 21 forming the drip tray is moved away from its position below the nozzle 22. Extending the piston and cylinder assembly 25 will move the drip tray provided by arm 21 back under the nozzle 22.

A deflector plate 26 minimizes the drift of spray into unwanted positions.

For non-organically grown plants sprays a fertilizer mix which will kill young plants could be used. This spray also has the advantage that it is a mix that the grower would usually apply after thinning thus allowing thinning and fertilizing to be achieved in one application.

When the invention uses a spray construction the raising and lowering aspects of the construction of FIGS. 1 and 2 may not be necessary although the spray nozzles 22 should be positioned as close to the expected position of the plants as possible.

FIGS. 5 and 6 show how the invention may be advantageously used in a weeding construction. The plant identification is effected substantially as for the thinning operation save that the image identification system is constructed to recognize weed plants that have different characteristics from the desired crop plant. In this construction a laser 30 is used although the flails and spray of the thinning constructions described above could be used.

Suitable sprays are organic herbicides such as GREEN MATCH which is a contact non-selective product used in California. This organic spray is useful for weed control on organic plants such as organic lettuce. The carefully directed nature of the spray may make this spray economical to use.

An “X-Y” table 31 is used which provides a cross member 32 on which the laser device 30 is mounted in a manner which allows the laser device 30 to move along the cross member 32 under the control of the computer and PLC.

The cross member 32 is mounted for transverse movement on a pair of stringers 33 and 34 again under the control of the computer and PLC.

When the imaging system detects a weed the laser 30 is directed to be positioned substantially above the weed by operation of the “X-Y” table and then the laser 30 is operated to substantially destroy the weed.

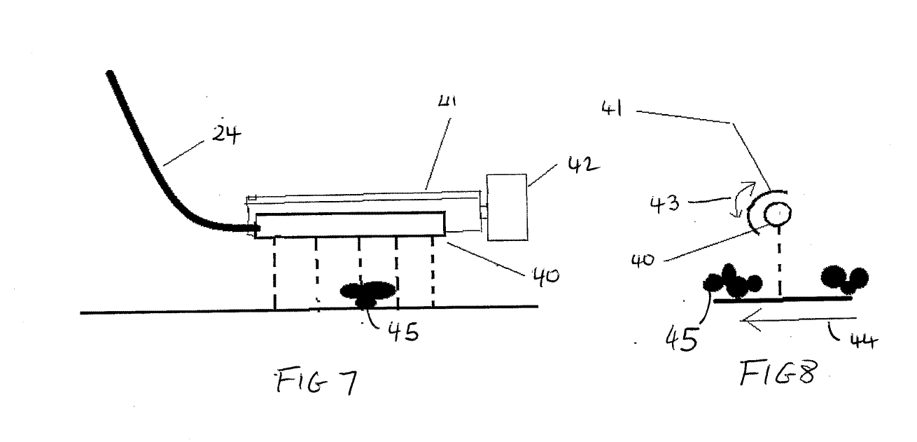

In the construction of FIGS. 7 and 8 spray line 24 feeds a spray bar 40 which is positioned at a suitable height above the ground. An arcuate drip tray 41 is mounted for rotational movement by a rotary actuator 42 such that the drip tray may be moved by the rotary actuator 42 in the directions of arrow 43. The intended direction of movement is shown by arrow 44. FIG. 8 shows the drip tray 41 in a withdrawn position so that spray may be applied to plants 45. When the spray bar 40 is not dispensing spray the drip tray 41 is moved to a position below the spray bar 40 so as to catch spray drips, if any, from the spray bar 40.

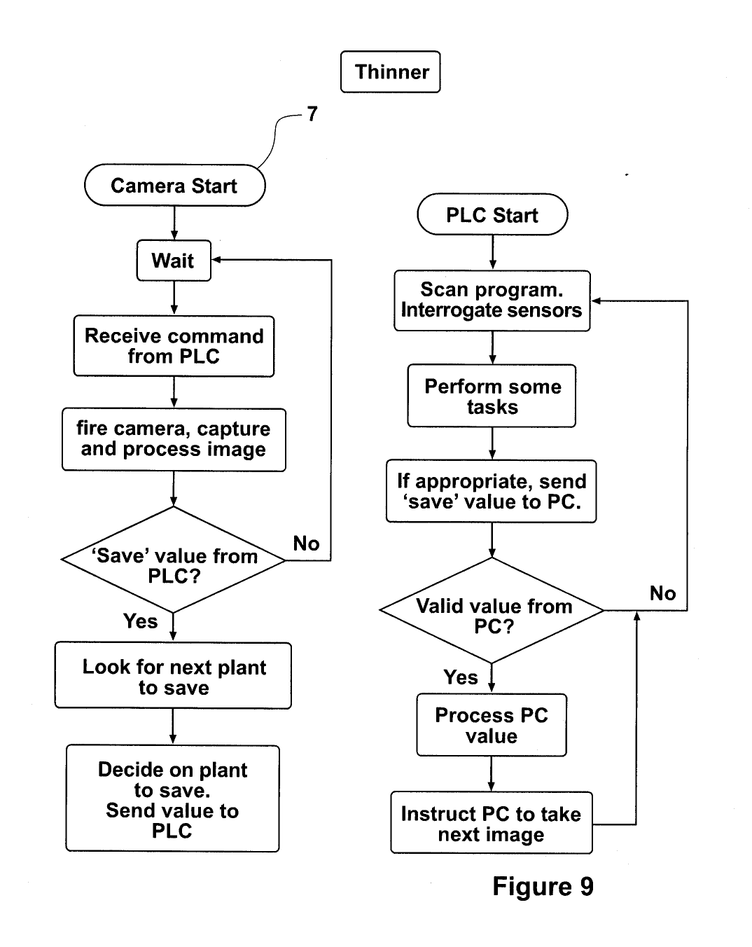

Referring now to FIG. 9 the camera 7 starts and waits until a command is received from the PLC. The camera then fires and an image of a plant is captured and processed. A decision is made as to whether a plant is to be saved or destroyed. If the plant is to be destroyed then the thinning means such as the flail or spray (or a laser) is operated and the selected plant is destroyed. The camera is then readied for the next image capture. If the plant is to be saved the step of destroying plants is of course omitted.

The tasks the PLC performs are:—to interrogate the height sensors and the encoder and scan the buffers where the ‘plant to save’ data is held. The PLC compares this data with the encoder value and, if the thinning apparatus has traveled far enough, the PLC will fire the appropriate outputs that control the spray nozzles or the cylinder that lifts the flail. It does this each time it runs through its code (every 2 or 3 milliseconds). If the camera has fired and processed an image, then the PLC will instruct it to do it over again. If the machine has advanced far enough for the PC to start looking for the next plant to save, the PLC will instruct it to do so. Then the PC will send saved plant data back with its next communication and the PLC will process that and add the result to the buffer.

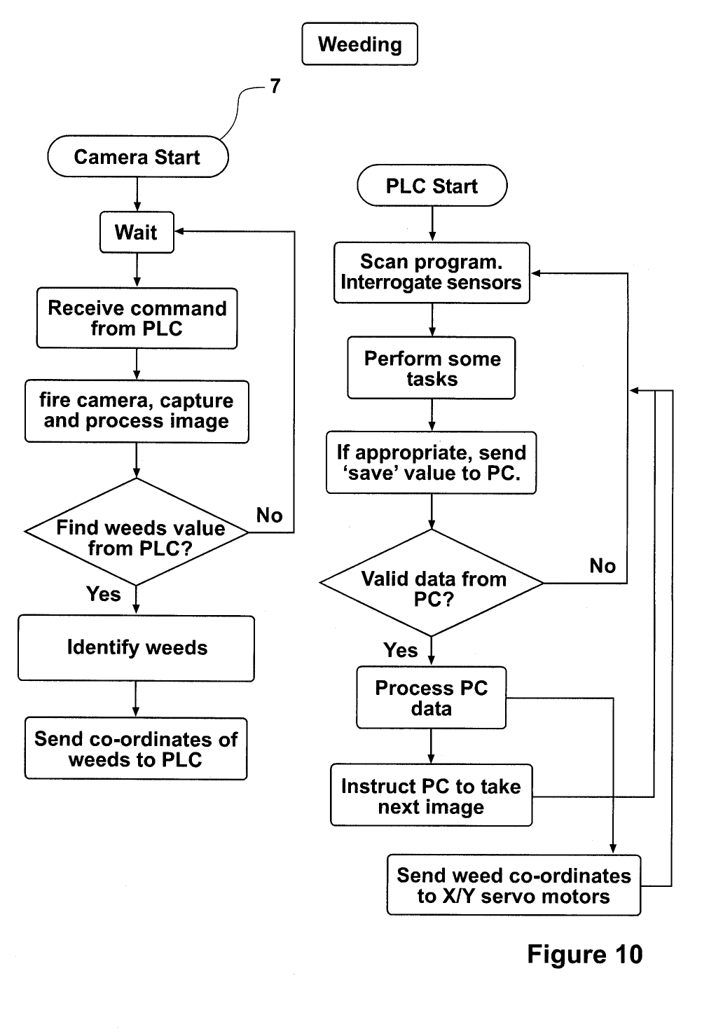

The arrangement shown in FIG. 10 is similar save that the construction is set to find and destroy weeds, which usually will differ in characteristics such as shape and colour from the crop plants that it is desired to retain.

It should also be understood that the term “comprise” where used herein is not to be considered to be used in a limiting sense. Accordingly, ‘comprise’ does not represent nor define an exclusive set of items, but includes the possibility of other components and items being added to the list.

The thinning system described herein is particularly suitable for lettuce that is planted in rows around ten or so inches (250 mm) between rows. The weeding system described herein is particularly suitable for organically grown baby leaf lettuce and other organic crops which are sown in rows less than two inches (50 mm) apart. Generally such crops are not thinned.

This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications and additions may be made thereto without departing from the scope thereof.

What we claim is:

1. A thinning or weeding apparatus including image processing apparatus, which image processing apparatus includes an automated visual detection system which comprises a visual sensor system and an image processing system capable of receiving an image from the visual sensor system and processing said image in the image processing system to determine where plants are located and to determine which plants will be thinned or weeded and which will not.

2. The apparatus of claim 1 wherein the plants are crop plants and the image processing system determines where the crop plants are located and optionally determines whether the crop plants are at a preferred predetermined spacing.

3. The apparatus of claim 1 wherein the apparatus is adapted to be mounted to the back of a tractor or any preferred vehicle having motive means, or is built as unit which is towed by the vehicle, or is motorized.

4. The apparatus of claim 1 wherein the apparatus is designed to pass across/over multiple rows of plants.

5. The apparatus of claim 1 wherein the image processing apparatus includes a visual sensor system adapted to capture or record an image of a bed of plants, or individual plants over which the apparatus travels.

6. The apparatus of claim 5 wherein the image capturing device is adapted to continually take images of the plants passing underneath the apparatus.

7. The apparatus of claim 5 wherein the apparatus also includes illumination means, preferably strobe lamps provided to facilitate improved image capturing by the image capturing device(s).

8. The apparatus of claim 1 wherein the image processing apparatus includes processing means and wherein the decisions/outcomes of the action of the image processing apparatus are sent to a PLC (programmable logic controller) which is adapted to track the progress of the thinning apparatus as it moves over the ground and wherein the PLC is further adapted to control the thinning or weeding assembly of the thinning or weeding apparatus so that the thinning or weeding assembly operates to destroy a pre-identified plant.

9. The apparatus of claim 1 wherein the thinning assembly includes thinning or weeding means.

10. The apparatus of claim 9 wherein the thinning or weeding means includes a rotating flail or rotating flails.

11. The apparatus of claim 10 wherein the or each rotating flail is comprised of a chain which is rapidly spinning.

12. The apparatus of claim 11 wherein during the thinning or weeding process the axis of rotation of the spinning flail or flails is directly above the row of plants.

13. The apparatus of claim 11 wherein the height of the axis of the spinning flail is controlled between a raised position whereby the thinning or weeding action is not achieved, and a lowered operational thinning or weeding position.

14. The apparatus of claim 13 wherein when the processing apparatus determines that a plant is not to be destroyed, the flail is raised to a height whereby contact with the plant is avoided and that plant is not subjected to damage and when the thinning or weeding apparatus has then passed over that plant, the flail is again lowered to destroy adjacent plants the processing apparatus determines are to be destroyed.

15. The apparatus of claim 14 wherein the thinning apparatus includes multiple flails, the position of each flail being adjustable to adapt the thinning apparatus for use with crop plants planted in parallel rows separated by predetermined distances and each flail being arranged laterally to an adjacent flail and located in an arrangement corresponding to the location of the parallel rows of plants.

16. The apparatus of claim 1 wherein the thinning or weeding assembly also includes drive means which drives the thinning or weeding means.

17. The apparatus of claim 16 wherein the thinning or weeding assembly also includes sensing means to determine the preferred height above ground to which the flails are moved to in their lowered position.

18. The apparatus of claim 17 wherein the sensing means are monitored to control hydraulic cylinders, one to each flail.

19. The apparatus of claim 17 wherein the thinning apparatus also is adapted to move sideways so that the flails are always in the correct lateral position this movement being controlled by a hydraulic cylinder which, in turn, is controlled by the PLC.

20. A method of thinning or weeding crop plants by using thinning or weeding apparatus, said thinning or weeding apparatus including, a thinning or weeding assembly carriage, and a thinning or weeding assembly, the method characterised by the steps of:
a) moving the thinning or weeding assembly carriage over a predetermined number of rows of plants, and
b) determining, by use of image processing apparatus the plants to be retained and the plants to be removed, and
c) lowering the thinning or weeding assembly over a plant to be removed and relative to the ground by means of positioning means and sensing means, and
d) activating thinning or weeding means, such that the plant determined to be thinned or weeded out is destroyed; and
e) returning the thinning or weeding assembly to a pre-thinning position until the next plant to be thinned or weeded is determined by the image processing means.
